(19) United States
(12) Patent Application Publication
(10) Pub. No.: US 2006/0015866 A1
(43) Pub. Date: Jan. 19, 2006

(54) System installer for a reconfigurable data center

(76) Inventors: Boon Seong Ang, Sunnyvale, CA (US); Michael Schlansker, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/892,570

(22) Filed: Jul. 16, 2004

(51) Int. Cl. G06F 9/445

(52) U.S. Cl. 717/174

(57) ABSTRACT

A system installer is operable to configure hardware components in a reconfigurable data center for a hardware platform. The system installer is also operable to install software on the hardware platform.

### BACKGROUND

Highly scalable computer systems of the future will be based on large ensembles of commodity components, such as processors, disk drives, memory, etc. As increasingly inexpensive, high-performance systems scale to even larger sizes, the task of managing hardware and software components and maintaining reliable and efficient computations with those components becomes increasingly complex and costly. For example, systems must be redeployed to accommodate evolving user demands without lots of manual rework. Typically physical reconfiguration of the components for redeploying systems to accommodate evolving user demands is performed by manually moving components or manually programming switches connecting components, such as blades and disk drives. For large-scale systems, the manual, reconfiguration becomes unmanageable, time consuming, and costly.

Some reconfigurable systems exist that allow for reconfiguration of hardware while minimizing manual labor. FPGAs (Field Programmable Gate Arrays) is an example of a reconfigurable device. FPGAs offer the ability to configure arbitrary logic and a small amount of flip-flop memory into different hardware designs through use of a hardware description language. While FPGAs enable a certain degree of configurability, their flexibility is limited to the chip level instead of the system level. Thus, for large-scale systems, where system components must be allocated to meet evolving user demands, FPGAs offer limited, system-level, physical customization.

Utiliity data centers offer some system-level customization. For example, components, such as servers and disk drives may be connected via a network, and disk drives may be allocated to certain servers to meet varying user demands. However, allocating disk drives to different servers requires a system administrator to program the network to provide the interconnections between the allocated servers and disk drives. Also, the physical reconfiguration of components may be limited to servers and disk drives.

As described above, conventional techniques for managing and configuring hardware are time consuming and costly. Conventional techniques for managing and configuring software for large-scale system is equally time consuming and costly. Typically, an ensemble of programs are needed to provide the desired functionality of a service. Individual programs in the service may be connected to appropriate input data sets, output data sets, and temporary data sets and I/O devices. Often, the output of one application in the service serves as an input to another application in the service. The tasks of selecting the software and selecting the hardware that work together to provide the service are usually performed manually by information technology (IT) experts. In addition, these experts have to instantiate many parameters for each application, which for some complex business software runs into hundreds of parameters. Proper selection of some parameters are necessary in order for the overall service to function at all, while choice of other parameters effects other important issues such as performance, security, and availability. Thus, the conventional approach to designing, configuring and deploying the software as well as the hardware is costly in terms of human labor, is prone to human error, and the quality of a deployment depends on the skills of the experts who perform these functions. Furthermore, the cost of using the experts to deploy a service may be encountered for each deployment instance of a service unless two instances are substantially similar in terms of their requirements, e.g. performance, security, availability, and their hardware platform and software. However, even a basic service deployment tends to change over time, resulting in increased design costs to accommodate changing service requirements.

### SUMMARY

A system installer is operable to configure hardware components in a reconfigurable data center for a hardware platform. The system installer is also operable to install software on the hardware platform.

### BRIEF DESCRIPTION OF THE DRAWINGS

The embodiments are illustrated by way of example and without limitation in the accompanying figures in which like numeral references refer to like elements, and wherein:

FIG. 1 shows a schematic diagram of a system for configuring a reconfigurable data center, according to an embodiment;

FIG. 2 shows a schematic diagram of a reconfigurable data center, according to an embodiment;

FIG. 3 shows a block diagram of a system installer, according to an embodiment;

FIGS. 4A-B show configuring a hardware platform, according to an embodiment;

FIG. 5 shows a disk provisioned for a processor in a hardware platform, according to an embodiment; and

FIG. 6 shows a flow chart of a method for configuring a hardware platform and installing software on the hardware platform.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

According to an embodiment, a reconfigurable data center comprises a collection of components, including processors, memories, disks, I/O devices, other devices, and an interconnection network that is programmable and facilitates flexible communication among the components. The components may be configured and reconfigured to meet varying user requirements. For example, a reconfiguration system may pair a processor with a suitable amount of memory, such as an appropriate amount of memory to support an application or multiple applications, to form a computer system, referred to as a physical platform. In this example, the paired processor and memory work together to meet the needs of the applications that the processor runs. Physical memory not needed for this physical platform is assigned to another physical platform. These physical platforms may then be reconfigured, for example, to meet new user requirements. A physical platform may also include multi-processor systems with shared memory, and physical platforms may include other types of components such as disks, I/O devices, cooling resources, network switches, etc.

The reconfigurable data center also includes software also needed to meet user requirements. In the reconfigurable data center, configuring and reconfiguring hardware and software is done programmatically, avoiding physical movement of hardware and labor-intensive software configuration.

1. System Overview

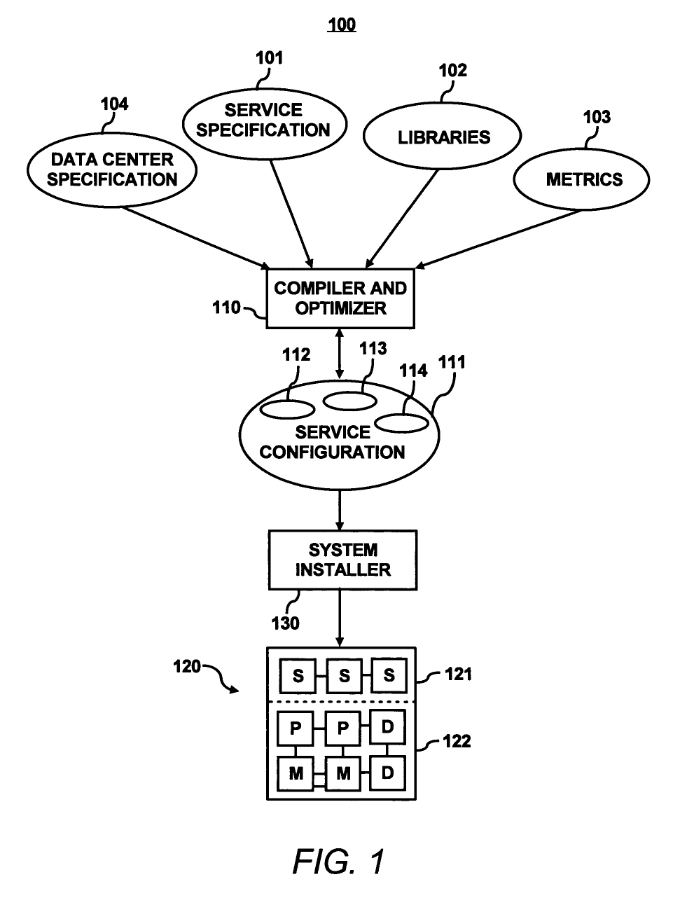

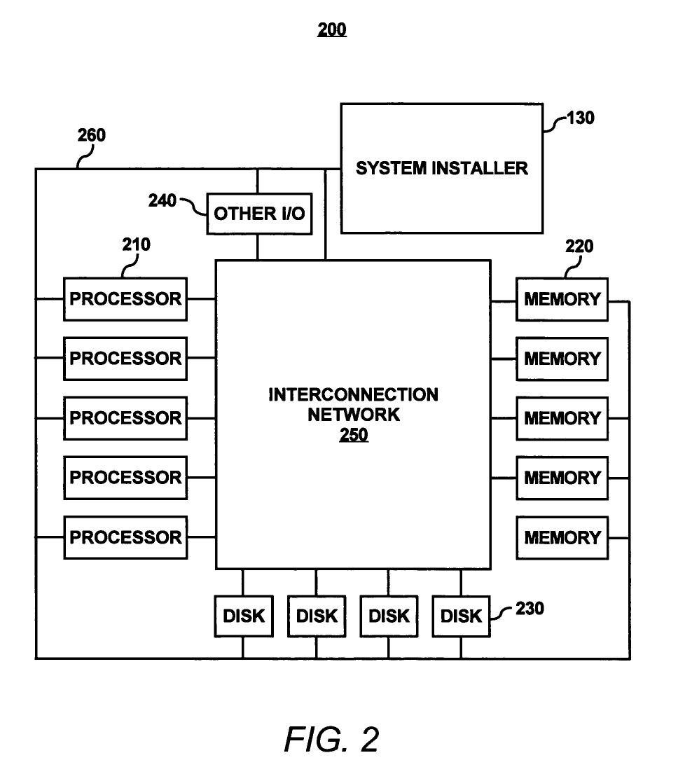

FIG. 1 illustrates a configuration system 100 for configuring a reconfigurable data center, according to an embodiment. The reconfigurable data center is shown in FIG. 2, and a portion of the reconfigurable data center that is configured for a service or a service component is shown as 120 in FIG. 1. A service is a combination of hardware and software components that is functional to meet predetermined requirements. For large-scale services, this may include one or more servers and the software, e.g., an ensemble of programs, needed to implement the desired functionality. A service component can be used with other service components to provide a service. A service component is software, hardware, or a combination of hardware and software that comprises a portion of a service. An example of a service may include an Internet retail service. Service components may include a web server, operating system, billing software, database, etc.

2. Compiler and Optimizer

The system 100 shown in FIG. 1 includes a compiler and optimizer 110. The compiler and optimizer 110 receives inputs including a service specification 101, libraries 102, metrics 103, and a data center specification 104. The outputs of the compiler and optimizer 110 is the service configuration 111, which includes descriptions of the hardware and software components in the reconfigurable data center to be used as hardware and software platforms for a service.

The compiler and optimizer 110 uses the service specification 101, the libraries 102, the metrics 103, and the data center specification 104 to synthesize the service configuration 111. Synthesis of the service configuration 111 and deploying a service including a hardware platform and software are described in detail in U.S. patent application Ser. Nos. TBD (Attorney Docket No. 200314985-1, 200314983-1, and 200314984-1), incorporated by reference in their entireties and described in detail below.

The service specification 101 and the libraries 102 are descriptions of a service, including a high-level description of the hardware and software components that can be used for the service. The service specification 101 is a high-level description of the service. The high-level description may be divided into a description of different components of the service. The high-level description in the service specification 101 is generally broad such that there may be several different hardware and software options for deploying the service. The libraries 102 may be hardware or software options that are available for deploying the service, and thus the libraries 102 may limit the number of configurations that may be used to provide the service. For example, a service may include an Internet retail service, and the service specification 101 includes a web server. The libraries 102 may include a library that limits the operating system (OS) for the web server to Freeware. Thus, the compiler and optimizer 110 may select a Freeware OS, such as Linux, rather than a proprietary OS. This may also effect the web server selection performed by the compiler and optimizer 110. For example, the web server selection may be limited to servers that can run the selected freeware OS. The metrics 103 are used to optimize the service configuration, such as selecting a service configuration that describes a hardware platform that best meets the metrics 103.

The data center specification 104 includes a list of components in the reconfigurable data center. The data center specification 104 may be used to describe all the components within the reconfigurable data center. The list in the data center specification 104 may include a description of the components, such as a description of the processors, memory modules, disks, I/O devices, and configurable switches in an interconnection network for the reconfigurable data center. An interconnection network as well as addressing in the reconfigurable data center and programming components in the reconfigurable data center to accommodate reconfiguration are described in U.S. patent application Ser. No. TBD (Attorney Docket No. 200314983-1), incorporated by reference above.

Instead of including a list of all the components in the reconfigurable data center, in another embodiment the data center specification 104 describes only the hardware components that are available to be deployed as a physical platform, such as the platform 120. For example, some components may be committed to prior uses and thus are unavailable, or some components may be malfunctioning and thus are unavailable. A data center specification that only includes available components may reduce testing and configuring process times when generating service configurations and deploying a service.

An example of a description in the data center specification 104 may include a description of processor type and processor speed. Memory and disks may also be characterized by size and speed (e.g. rotational speed and seek time). Other components described in the data center specification 106 may include I/O or graphics display hardware. The description of the components may include a number of ports that are used to connect the components into a larger system in order to support communication between the components. Within the reconfigurable data center, the components are connected with a network of links and switch units that provide communication, i.e., components in an interconnection network. Connected and coupled as used herein refers to components or devices being in electrical communication. The electrical communication may be via one or more other components or may simply be between the components sending and receiving information. The data center specification 104 may also include a description of the number and type of switches and switch ports that can be used for a physical platform. Network connections may be described in the data center specification 104 through a description of links. A link may connect a component to a switch object, a switch to a switch, or a component to another component. Non-point-to-point physical networks, such as broadcast networks that connect a single output port to many input ports, may also be described in the data center specification 104 if a non-point-to-point physical network is provided in the reconfigurable data center.

The data center specification 104 and the service specification 101 are described in further detail with respect to U.S. patent application Ser. No. TBD (Attorney Docket Number 200314984-1), which is incorporated by reference above. It should be noted that the 200314984-1 also describes a logical platform specification, which includes a description of hardware components to be configured to meet user requirements. In the embodiment described herein, the logical platform specification is incorporated into the service specification 101, and the output of the compiler and optimizer 110 resulting from the logical platform specification is incorporated into the service configuration 111.

Based on the service specification 101, the libraries 102, and the data center specification 104, the compiler and optimizer 110 generates multiple candidate service configurations. For example, the service specification 101 is instantiated with different parameters resulting in several possible service configurations. Returning to the example with the Internet retail service, a service configuration may be generated including a Freeware OS running on a 4-way multiprocessor or a proprietary OS running on a 4-way multiprocessor but requiring more memory. Through a recursive process and based on constraints and the metrics 103, the compiler and optimizer 110 selects a single service configuration for deployment, such as the service configuration 111. For example, a user constraint, which may be provided in the service specification 101 or a library may require a Freeware OS, so the configuration with a proprietary OS is not selected. Also, the metrics 103 may include selecting a service configuration that is cheapest to use or provides the greatest throughput. The compiler and optimizer 110 may simulate and test candidate service configurations based on the metrics 103 and selects a configuration that best meets the metrics 103 and user constraints. The metrics 103 may also be provided in the service specification 101 and the libraries 102.

3. System Installer Overview

The system installer 130 receives as input the service configuration 111. The system installer 130 deploys the platform 120 from components in the reconfigurable data center, including the hardware components 122, referred to as the hardware platform, and the software components 121.

The service configuration 111 is comprised of three components, a system software configuration 112, an application software configuration 113, and a logical hardware platform configuration 114. The system software configuration 112 is a description of the software components needed for deploying the system software, such as a BIOS (basic I/O services), operating system, etc. The system application configuration 113 is a description of the software components needed for deploying the system applications, which are applications such as billing software, web hosting software, etc. for the Internet retail service example. A logical hardware platform configuration 114 is a description of the hardware components, e.g., hardware components available in the reconfigurable data center, needed to implement a hardware platform for the system software and system applications.

The system installer 130 uses the service configuration 111, including its components 112-114, to deploy the platform 120 (shown in FIG. 1) including software components 121 and hardware components 121 comprised of hardware and software components in the reconfigurable data center.

The system installer 130 provides an automated deployment capability for automating the process of installing and configuring hardware, system software, and application software. The system installer 130 performs the needed installation and configuration, enforcing any sequencing as specified within an installer script. The installer script ensures that installations are performed in a correct order. For example, a hardware platform must be installed or configured before an operating system can be installed on that hardware platform. An operating system must be installed before an application can be installed on that operating system. The system installer 130 provides the sequencing for loading software, such as the software components 121 on the hardware platform comprised of the hardware components 122.

4. Reconfigurable Data Center with System Installer

FIG. 2 illustrates a reconfigurable data center with the system installer 130. Although not shown, the compiler and optimizer 110 is connected to the system installer 130 as shown in FIG. 1. Connected as used herein means in electrical communication, which may include direct communication between two components or communication via one or more other components through a known communication medium.

The reconfigurable data center 200 includes hardware components, such as processors 210, disks 230, memory 220, other I/O components 240 and an interconnection network 250 that can be configured to form one or more a logical computer systems from the hardware components in the reconfigurable data center and installed software. A traditional hardwired computer system has a fixed association among its hardware components and includes one or more busses connecting the hardware components. Conventionally, redeploying the hardware components of a traditional computer system is performed by physically moving the components. As such, memory chips, disk controllers, network adaptors, or other replaceable units are added or removed in order to construct or provision a system having adequate capability. The reconfigurable data center 200 does not require physically moving components to reconfigure a computer system. Instead, the interconnection network 250 and other components are programmable to associate and re-associate different select components to reconfigure a computer system.

The components 210-250 in the reconfigurable data center 200 can be configured to form one or more logical computer systems including installed software. An example of a logical computer system is the platform 120 shown in FIG. 1. A logical computer system may include one or more of the processors 210 shown in FIG. 2 provisioned with an appropriate amount of memory 220, disk(s) 230, and/or other appropriate I/O capability such as network or graphics I/O 240 and disks. Shared memory multiprocessors can also be configured that allow multiple processors to share memory.

The selection of the hardware components for the logical computer system is based on the service configuration 111 and in particular the logical hardware platform configuration 114. The system installer programs the hardware components in a logical computer system to work together. For example, the system installer 130 programs the interconnection network 250 to allow the components of the hardware platform 120 shown in FIG. 1 to communicate with each other. This may include repopulating routing tables within the interconnection network 250 to provide for the communication. The system installer 130 may also program address conversion units (e.g., address translation units, address manipulation units, etc.) and address conversion tables provided therein to allow the processors to access memory. This may include repopulating address conversion tables, such as mapping tables, in the address conversion units with values that provide for addressing between a processor in the logical computer system and memory provisioned for the processor in the logical computer system. Programming the interconnection network 250 and address conversion units is additionally described in U.S. patent application Ser. No. TBD (Attorney Docket No. 200314983-1), which is incorporated by reference above. The system installer 130 is also operable to program disks and other peripheral or I/O devices in the logical computer system, such as described in detail below.

A logical computer system, in addition to hardware components, includes software components (e.g., the software components 121 shown in FIG. 1) including installed system software (e.g., OS, BIOS, etc.) and applications. The system installer 130 is operable to install system software and applications on a hardware platform, such as the hardware platform 122 shown in FIG. 1. In one embodiment, the system installer 130 is connected to a configuration broadcast channel 260, shown in FIG. 2, that provides the system installer with direct access to substantially every configurable component in the reconfigurable data center 200. This provides simple direct access and allows any component to be configured irrespective of the state of other components. The configuration broadcast channel 260 also has the advantage that it can communicate directly with any component without perturbing the operation of other components in the reconfigurable data center that are busy executing critical applications.

The broadcast channel 260, for example, may include a 1-bit serial line connected to all the components 210-240 or some other form of a direct communication channel to the components 210-240. The system installer 130 may use this line to quickly determine the status of a component and to provide low-level instructions to the components 210-240, such as instructing a component to enter a predetermined state. This predetermined state may include a bare mode state which is described in detail below.

The system installer 130 is also connected to the interconnection network 250 and to the components 210-240 via the interconnection network 250. The interconnection network 250, as opposed to the broadcast channel 250, supports high-performance system execution, and thus may be used program the hardware components 210-240 and install software in a logical computer system in an accelerated pace. For example, the system installer 130 may use the interconnection network 250 to transfer large blocks of data needed to program hardware components and install software.

5. System Installer Components

The system installer 130 uses the service configuration 111, including its configurations 112-114 shown in FIG. 1, to deploy a platform including hardware and software that meets the requirements provided in the service specification 101 and provides the functionality desired by the user. Deploying the platform includes configuring or programming hardware components in the reconfigurable data center 200 and installing system software and applications on the hardware components.

The system installer 130 stores unique identifiers for each hardware component in the reconfigurable data center 200 and can communicate with each of the hardware components via a communication path, such as the broadcast channel 260 or the interconnection network 250, using the unique identifier. The interconnection network 250 may need to be initialized by the system installer, e.g., populating routing tables in switches in the interconnection network 250, in order to establish a communication path between a hardware component and the system installer 130. Using the communication path, the system installer 130 sends commands to the hardware components causing a configuration operation to be executed. The configuration operation may have the effect of configuring the selected hardware component to a configuration that is specified by the service configuration 111 shown in FIG. 1. The system installer 130 is also operable to retrieve data from a specific hardware component using its ID. This can be used, for example, to ensure that a configuration operation is successfully completed prior to initiating a subsequent configuration operation that depends upon the completion of a prior operation. For example, a communication path or channel in the interconnection network 250 might be configured before it is used to configure additional hardware components that connect to that channel.

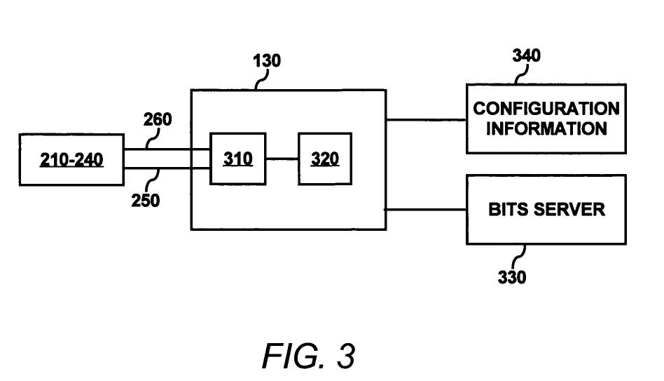

FIG. 3 illustrates a block diagram of the system installer 130. The system installer 130 includes a coordinator 310 for configuring hardware components to function as a hardware platform based on the service specification 111 shown in FIG. 1. The coordinator 310 also installs the software on the hardware components, which is also based on the service specification 111. The result is a configured platform, such as the platform 120 shown in FIG. 1, that is a computer system providing the desired service.

The coordinator 310 runs scripts 320 for configuring the hardware components and installing the software. The scripts 320 may be received from the compiler and optimizer 110 as the service configuration 111, or the coordinator may convert the received service specification 111 into scripts for configuring the hardware components and installing the software. The system installer 130 also includes a bits server 330 storing software to be installed on hardware components 121. The bits server 330 may store BIOS, OS, and applications. The system installer may also include memory or other type of storage 340 for storing the IDs for the hardware components in the reconfigurable data center.

The coordinator 310 uses a scripting language to generate and/or execute the scripts 320. The scripts 320 may be hierarchical, and thus the coordinator 310 may build a script by incorporating scripts that configure multiple sub-systems that ultimately operate as a complete computer system. The scripts 320 may be used to control and query the state of hardware components in the reconfigurable data center 200 through the broadcast channel 260 or the interconnection network 250. This in turn allows the system installer 130 to configure address conversion tables used by processors to access memory provisioned for the processors, routing tables for switches in the interconnection network 250 to allow hardware components for a platform to communicate with each other, memory contents, and processors as needed. In addition to querying the state of hardware components, the scripts 320 may specify a collection of hardware actions or sub-installations that configure logical hardware systems within a reconfigurable data center 200. The scripts 320 may also specify a collection of software actions or sub-installations that configure software systems to run on logical hardware systems and specify an order for hardware and software sub-installations.

A shown in FIG. 3, the coordinator 310 executes the scripts 320, which generates commands transmitted to the hardware components through the broadcast channel 260 or the interconnection network 250 to configure the hardware components and install software. One example of a command includes an op-code transmitted through the broadcast channel 260 to a hardware component to retrieve the state of the hardware component or a command to place the hardware component in a bare-mode state. In another example, software may be transmitted through the interconnection network 250 for installation on one or more of the hardware components.

5. Bare Mode Program Installation, OS Installation, and Application Installation

Computer systems have traditionally required some capability for initial program load that allows a computer that has just been powered up to progress through an orderly sequence of steps that finally leads to a full operating system install. According to an embodiment, the system installer 130, including the coordinator 310, performs an initial bare mode program installation of a hardware platform after the hardware platform is initially configured. In this mode, the system installer 130 invokes a processor in a hardware platform to load programs of increasing complexity from an un-initialized state.

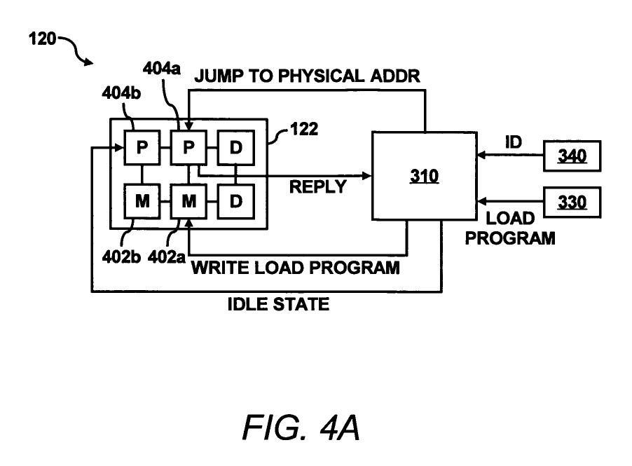

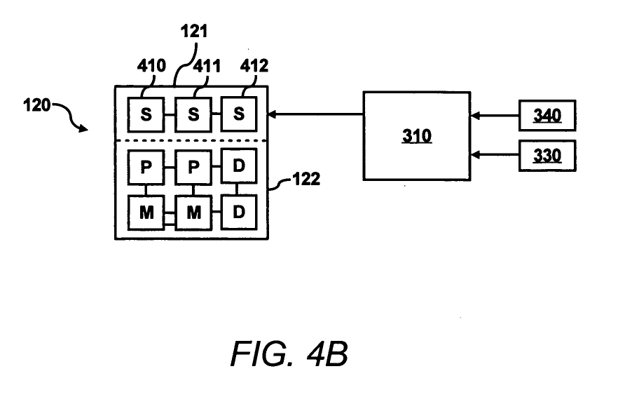

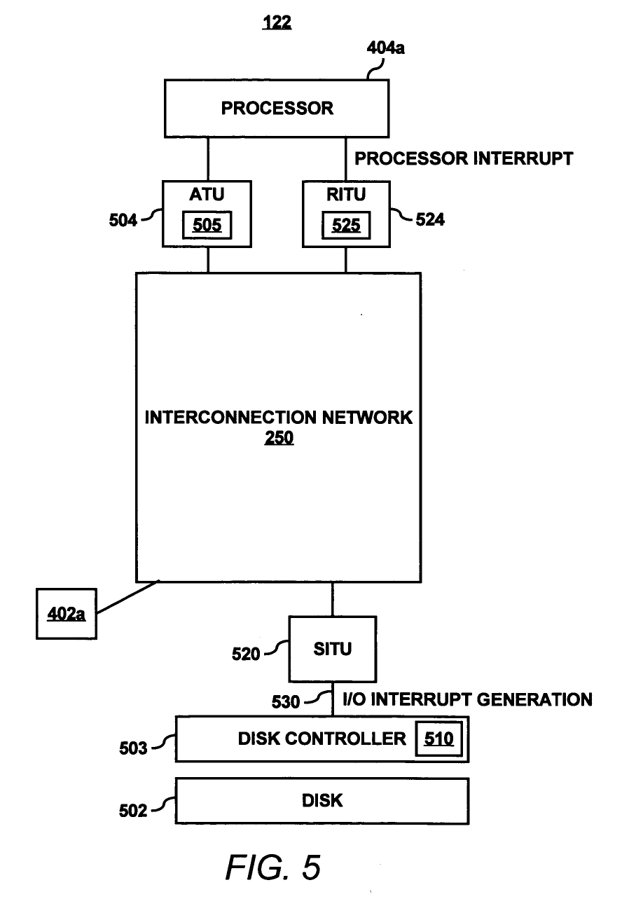

FIG. 4A illustrates an example of bare mode program installation on the hardware platform 122 after the hardware platform 122 is initially configured by the system installer 130. For example, the system installer 130 configures the hardware platform 122 based on the service specification 111 shown in FIG. 1. This may include provisioning memory, disks and I/O devices for the processors and programming the interconnection network 250 to allow these components to communicate with each other. Configuring the hardware platform 122 is also described with respect to FIG. 5.

After initial configuration of the hardware platform 122, the coordinator 310 writes a load program into the memory module 402a provisioned for the processors 404a and 404b in the hardware platform 122. In this example, the hardware platform 122 includes a multiprocessor platform with shared memory and disks, which may include the processors 404a and 404b, shared memory modules 402a and 402b, and disks. The hardware platform 122 exists within a reconfigurable data center that includes other processors, other memory modules, and other disks which may be provisioned for other platforms that simultaneously exist within the reconfigurable data center with the hardware platform 122. The coordinator 310 may retrieve the load program from the bits server 330 and using an ID for the memory module 402a writes the load program to a predetermined memory location in the memory module 402a. A predetermined physical address associated with the memory location is used by the processor 404a to run the load program.

The coordinator 310 puts the processors 404a and 404b in the hardware platform 122 in an idle state, such as an idle loop, which ensures that the processors 404a and 404b do not access the memory modules 402a and 402b. Also, when the memory modules 402a and 402b are provisioned for the processors 404a and 404b, the interconnection network is configured such that other processors in the reconfigurable data center cannot access the memory modules 402a and 402b.

The coordinator 310 transmits a command, for example via the broadcast channel 260 shown in FIGS. 2 and 3, to the processor 404a to run the load program by accessing the predetermined memory location, which may include multiple memory locations, referenced by the predetermined physical address. The processor 404a may send a reply to the coordinator 310 when the load program is run or finished running. The load program installs a BIOS and tests the hardware in the hardware platform 122. The load program also loads an operating system. Then, the coordinator 310 may install applications on the hardware platform 122.

The load program may be defined to perform any functions required by a specific hardware platform in its bare mode. The load program may cause the processor 404a to load a BIOS from the bits server 330. A BIOS performs some traditional low-level setup functions, such as initializing and testing critical components such as memory, disks, and other peripheral devices, before it transfers control to the boot loader which then loads the OS. The BIOS or the load program also include basic networking software to allow the hardware platform 122 to use the interconnection network 250 for installing other software, such as an OS and applications. For example, the BIOS initializes a network interface, i.e., an I/O device, to the interconnection network 250 so that it is functional.

Security can be used to ensure the integrity of the coordinator-client communication. One approach is to use communication infrastructure hardware that can ensure security, e.g. dedicated communication path that cannot be accessed by other entities such as the broadcast channel 260. Alternatively, authentication and encryption (or signing of messages) is used to establish identity as well as to guard against tempering. For example, just as each hardware component is provided an ID, encryption keys can be pre-established at each hardware platform in the reconfigurable data center 200 for either secret or public key encryption. Security software may be included in the BIOS.

After the BIOS is installed, the OS is installed and then applications running on the OS may be installed. This is illustrated with respect to FIG. 4B. The coordinator 310 installs the BIOS 410, such as described above. The BIOS installs the OS 411, and then the coordinator 310 installs the applications 412.

6. Configurable Disk I/O System

The system installer 130 is used to configure hardware components and install software. One aspect of configuring the hardware components as a hardware platform includes provisioning memory for processors. This is described below and in detail in U.S. patent application Ser. No. TBD (Attorney Docket Number 200314983-1) incorporated by reference in its entirety above. Another aspect of configuring hardware components includes provisioning and configuring peripheral devices for a hardware platform, such as disks, network devices, graphics adaptors, etc.

FIG. 5 illustrates how a peripheral device such as a disk can be configured or provisioned for use by a processor. Other examples of the peripheral device include a graphics adaptor, network interface, or other peripheral device. The system installer 130 provisions the peripheral devices for one or more processors in a hardware platform. By provisioning a peripheral device, such as a disk, for a processor, the processor may access the disk to perform various data operations, such as reads and writes.

In order to control a peripheral device or determine the status of a peripheral device provisioned for the processor, the processor writes to a physical address that is converted by an address translation unit to one or more addresses of memory locations assigned as device status and control registers. These memory locations may be located in a memory module, in a device controller, or even in an interrupt generation unit. The processor reads values in the device status registers to determine the status of the device and writes to the control registers to control functions for the device. The control and status registers are initialized by the system installer 130 to reside at certain physical addresses that are visible to a designated processor, such that the processor accesses the registers by referencing one or more predetermined physical addresses.

FIG. 5 illustrates an example of configuring a peripheral device comprising a disk, according to an embodiment. Configuring a peripheral device is similar to configuring memory. Configuring a peripheral device is described with respect to a translate at root embodiment, where address translation for accessing a peripheral device is performed at or near a processor accessing the device. The translate at root embodiment is an example of a configuration technique for programming or changing the association of a peripheral device, such as a disk, and a disk controller with different logical hardware platforms through electronic reconfiguration. Alternate embodiments for configuring a peripheral device may be used, such as a translation at leaf technique. Both the translate at root and the translate at leaf techniques are described in the aforementioned patent application.

FIG. 5 shows the processor 404a, the memory module 402, and a disk 502 for the hardware platform 122 shown in FIGS. 1 and 4A-B. Other hardware components for the hardware platform 122 are not shown for purposes of illustrating configuring a peripheral device, according to an embodiment. The processor accesses the memory module 402 and the disk 402 by referencing physical addresses. These physical addresses are converted by an address translation unit 504 to addresses for the memory module 402 and the disk 502. The address translation unit 504 may include one or address conversion tables 505 which are populated by the system installer 130, which is one form of configuring hardware components in a hardware platform. These address conversion tables 505 are used to convert physical addresses for the processor 402a to addresses for memory and disks provisioned for the processor 402a. The values in the tables 505 may be changed by the system installer 130 after a reconfiguration of the hardware components in the hardware platform 122 results in the processor 402a being assigned to different memory modules and peripheral devices.

The processor 402a may send a request, such as a read or write request, to the disk controller 503 by referencing a physical address assigned to the disk 502 or the disk controller 503. The request is transmitted to the disk controller 503 via the address translation unit 504 and the interconnection network 250 to the disk controller. The disk controller 503 controls the disk 502 to perform the request.

Disks and other peripheral devices rely on interrupts to signal the completion of a task or operation, such as completion of a read or a write operation. This avoids the need for a processor to periodically check a device's status for task completion. The hardware platform 122 includes a sending interrupt generation unit (SITU) 520 and a receiving interrupt generation unit (RITU) 524. These units are used to generate interrupts detectable by the processor 402a via the interconnection network 250 to, for example, signal completion of a disk operation. When the disk controller 503 detects the completion of an operation, the disk controller 503 raises an interrupt signal on an I/O interrupt generation line 530 connected to the SITU 520. The SITU 520 is configured to write an appropriate control register 525 within the RITU 524. The RITU 524 detects the control register write and generates an interrupt signal that is detectable by the processor 402a. In this way, the reconfigurable memory system is used to configure the transmission of both data and interrupts between processors and peripheral devices.

The processor 402a can also access status and control registers 510 by referencing one or more predetermined physical addresses, which are assigned by the system installer 130. The ATU 504 converts the physical address to an address associated with the status and control registers 510. The status and control registers 510 may include memory locations within a memory module, such as the memory module 402, memory locations in the disk controller 503, or memory locations in the RITU 524 or SITU 520. The status and control registers 510 may be read by the processor 402a to determine the status of the disk 502 or may be written to by the processor 402a to control functions of the disk 502 such as known in the art.

It will be apparent to one of ordinary skill in the art that the hardware platform 122 may include more than one address translation unit or may include an address translation unit located between the interconnection network 250 and the peripheral devices, such as described with respect to the translated-at-leaf embodiment described in the aforementioned patent application.

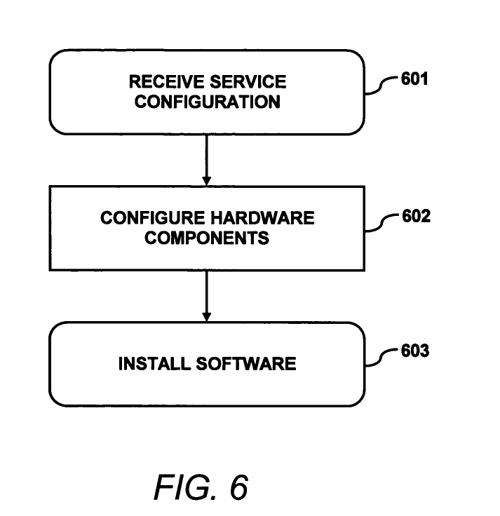

FIG. 6 illustrates a method 600 for configuring hardware components and installing software in a reconfigurable data center according to an embodiment. The method 600 is described with respect to FIGS. 1-5 by way of example and not limitation. At step 601, the system installer 130 receives the service configuration 111 from the compiler and optimizer 110.

At step 602, the system installer 130 configures hardware components in the reconfigurable data center 200 as the hardware platform 122 based on the service configuration 111. This includes selecting hardware components available in the reconfigurable data center 200 based on the logical hardware platform configuration 114 of the service configuration 111. The system installer 130 configures these hardware components to function together to operate as a computer system providing the desired functionality of a user. Configuring the hardware components may include populating address conversion tables in address translation units, populating routing tables in network switches in the interconnection network 250, provisioning memory and peripheral devices for processors, etc.

At step 603, the system installer 130 installs software on the hardware platform 122 based on the service configuration 111. This includes selecting software based on specifications in the systems software configuration 112 and the application software configuration 113 shown in FIG. 1. Installing software may include placing a load program in a memory location that corresponds to a predetermined physical address for the processor 402a in the hardware platform 122, and transmitting a command to the processor 402a in the hardware platform 122 to access the memory location using the predetermined physical address to run the load program. The load program instructs the processor 402a to install a BIOS on the hardware platform by running the load program. The BIOS may be configured and initially stored at the system installer 130. An operating system and applications are then installed on the hardware platform 122.

The steps for the method 600 may be contained as a utility, program, subprogram, in any desired computer accessible medium. The steps may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

What has been described and illustrated herein are the embodiments along with some of its variations. The terms, descriptions and figures used herein are set forth by way of illustration only and are not meant as limitations. Those skilled in the art will recognize that many variations are possible within the spirit and scope of the embodiments, which intended to be defined by the following claims and their equivalents in which all terms are meant in their broadest reasonable sense unless otherwise indicated.

What is claimed is:

1. An apparatus comprising:
a system installer;
data storage storing software and connected to the system installer;
wherein the system installer is operable to configure hardware components in a reconfigurable data center as a hardware platform and is operable to install software from the data storage on the hardware platform.

2. The apparatus of claim 1, further comprising:
a compiler and optimizer operable to generate a service configuration from a service specification and a data center specification; and
the system installer is operable to use the service configuration to select and configure the hardware components and select the software to install on the hardware platform.

3. The apparatus of claim 2, further comprising:
scripts generated from the service configuration; wherein the system installer is operable to execute the scripts to configure the hardware components and install the software.

4. The apparatus of claim 3, wherein the scripts comprise at least one of a script identifying hardware components for the hardware platform, a script identifying software to be installed on the hardware platform, and a script identifying an order for configuring hardware and installing software.

5. The apparatus of claim 1, further comprising at least one communication path between the system installer and the hardware components.

6. The apparatus of claim 5, wherein the at least one communication path comprises a broadcast channel including a communication path dedicated for communications between hardware components in the reconfigurable data center and the system installer.

7. The apparatus of claim 5, wherein the at least one communication path comprises an interconnection network including reconfigurable switches operable to be configured by the system installer to provide communication between the hardware components in the hardware platform and communication between the hardware components and the system installer.

8. The apparatus of claim 5, wherein the system installer is operable to communicate with each of the hardware components via the at least one communication path using a unique ID for each hardware component.

9. The apparatus of claim 5, wherein the system installer is operable to transmit a command via the at least one communication path to at least one of the hardware components to cause the at least one hardware component to perform a configuration operation.

10. The apparatus of claim 9, wherein the system installer is operable to receive a reply from the at least one hardware component via the at least one communication path associated with the configuration operation.

11. The apparatus of claim 9, wherein the system installer is operable to place a load program in a memory location that corresponds to a predetermined physical address for the hardware platform.

12. The apparatus of claim 9, wherein the command comprises a command causing a processor in the hardware platform to access the load program by referencing the predetermined physical address.

13. The apparatus of claim 9, wherein the load program installs a BIOS on the hardware platform.

14. The apparatus of claim 13, wherein the BIOS performs at least one of initializing and testing memory, disks, and other peripheral devices, running a boot loader to load an operating system on the hardware platform, initializing an interface to the at least one communication path, and installing encryption software.

15. The apparatus of claim 12, wherein the command comprises a command causing another processor in the hardware platform to enter an idle state.

16. The apparatus of claim 13, wherein the system installer installs applications from the data storage on the hardware platform.

17. The apparatus of claim 16, wherein the system installer selects the applications based on user requirements.

18. The apparatus of claim 13, wherein the system installer configures the BIOS based on user requirements.

19. The apparatus of claim 1, wherein the hardware components comprise at least one processor, at least one memory module, and at least one disk.

20. The apparatus of claim 19, wherein the hardware components further comprise switches in an interconnection network used for communicating between the hardware components and communicating between the hardware components and the system installer.

21. The apparatus of claim 19, wherein the hardware components further comprise at least one graphics adaptor and at least one network interface.

22. The apparatus of claim 19, wherein the system installer is operable to provision the at least one memory module for the at least one processor by loading address conversion tables with values that allow the at least one processor to access the at least one memory module.

23. The apparatus of claim 19, wherein the system installer provisions the at least one disk for the at least one processor by populating an address conversion table such that a predetermined physical address used by the at least one processor references at least one memory location acting as a status or control register for the at least one disk.

24. The apparatus of claim 19, wherein the at least one memory location acting as a status or control register is provided in the at least one memory module or an interrupt unit connected to the at least one processor.

25. A method comprising:
receiving a service configuration;
configuring hardware components in a reconfigurable data center as a hardware platform based on the service configuration using a system installer connected to the hardware components; and
installing software on the hardware platform based on the service configuration using the system installer.

26. The method of claim 25, further comprising:
configuring at least one processor and at least one memory module in the reconfigurable data center for the hardware platform.

27. The method of claim 26, wherein configuring at least one processor and at least one memory module further comprises populating an address conversion table with values that allow the at least one processor to access memory locations in the at least one memory module using physical addresses.

28. The method of claim 26, further comprising:
configuring at least one disk in the reconfigurable data center for the hardware platform.

29. The method of claim 26, wherein configuring at least one disk further comprises:
populating an address conversion table such that a predetermined physical address accessed by the at least one processor references at least one memory location acting as a status and control register for the at least one disk.

30. The method of claim 28, further comprising:
configuring switches in an interconnection network allowing the at least one processor, the at least one memory module, the at least one disk, and the system installer to be in communication.

31. The method of claim 25, wherein installing software on the hardware platform further comprises:
placing a load program in a memory location that corresponds to a predetermined physical address for the hardware platform;
and transmitting a command to a processor in the hardware platform to access the memory location using the predetermined physical address to run the load program.

32. The method of claim 31, further comprising:
installing a BIOS on the hardware platform by running the load program.

33. The method of claim 33, further comprising:
installing an operating system from the system installer on the hardware platform.

34. The method of claim 34, further comprising:
installing applications from the system installer on the hardware platform.

35. An apparatus comprising:
means for receiving a service configuration; and
system installer means for configuring hardware components in a reconfigurable data center as a hardware platform based on the service configuration and for installing software on the hardware platform based on the service configuration.

36. The apparatus of claim 35, further comprising:
means for connecting the system installer means to the hardware components.

37. The apparatus of claim 35, further comprising:
configurable interconnection network means for providing a communication path between the hardware components and between the hardware components and the system installer means.

38. The apparatus of claim 35, further comprising:
compiler and optimizer means for generating the service configuration based on user requirements.

39. The apparatus of claim 35, wherein the software comprises a BIOS, operating system, and at least one application.

40. A computer readable medium on which is embedded one or more computer programs, said one or more computer programs implementing a method for configuring a reconfigurable data center, said one or more computer programs comprising a set of instructions of:
receiving a service configuration;
configuring hardware components in a reconfigurable data center as a hardware platform based on the service configuration using a system installer connected to the hardware components; and
installing software on the hardware platform based on the service configuration using the system installer.

41. The computer readable medium of claim 40, wherein said one or more computer programs further comprises instructions of:
configuring at least one processor and at least one memory module in the reconfigurable data center for the hardware platform.

42. The computer readable medium of claim 41, wherein said one or more computer programs further comprises instructions of:
configuring at least one disk in the reconfigurable data center for the hardware platform.

43. The computer readable medium of claim 42, wherein configuring at least one disk further comprises:
populating an address conversion table such that a predetermined physical address accessed by the at least one processor references at least one memory location acting as a status and control register for the at least one disk.

44. The computer readable medium of claim 42, wherein said one or more computer programs further comprises instructions of:
configuring switches in an interconnection network allowing the at least one processor, the at least one memory module, the at least one disk, and the system installer to be in communication.

45. The computer readable medium of claim 40, wherein installing software on the hardware platform further comprises:
placing a load program in a memory location that corresponds to a predetermined physical address for the hardware platform;
and transmitting a command to a processor in the hardware platform to access the memory location using the predetermined physical address to run the load program.

46. The computer readable medium of claim 45, wherein said one or more computer programs further comprises instructions of:
installing a BIOS on the hardware platform by running the load program.

47. The computer readable medium of claim 46, wherein said one or more computer programs further comprises instructions of:
installing an operating system from the system installer on the hardware platform.

48. The computer readable medium of claim 47, wherein said one or more computer programs further comprises instructions of:
installing applications from the system installer on the hardware platform.

49. A reconfigurable data center comprising:
a processor;
a device provisioned for the processor; and
an address translation unit operable to translate a physical address assigned to the processor to an address of a controller for the device; and
an interconnection network operable to route a request to the controller using an address translated from the physical address by the address translation unit.

50. The reconfigurable data center of claim 49, further comprising:
a system installer operable to assign memory locations in memory as control and status registers for the device.

51. The reconfigurable data center of claim 50, wherein the system installer assigns at least one physical address for the processor to the memory locations for the control and status registers.

52. The reconfigurable data center of claim 51, wherein the address translation unit converts the at least one physical address for the processor to at least one address associated with the memory locations for the control and status registers, such that the processor is operable to access the memory locations.

53. The reconfigurable data center of claim 49, further comprising:
interrupt generation units including a sending interrupt translation unit and a receiving interrupt translation unit, wherein the interrupt generation units are operable to generate an interrupt through the interconnection network that is detectable by the at least one processor, the interrupt being associated with a completion of an operation associated with the request.

54. The reconfigurable data center of claim 53, wherein the controller detects the completion of the operation and generates an interrupt signal on an interrupt generation line that is connected to the sending interrupt translation unit.

55. The reconfigurable data center of claim 54, wherein the sending interrupt translation unit is operable to write to a control register in the receiving interrupt translation unit in response to detecting the interrupt signal on the interrupt generation line.

56. The reconfigurable data center of claim 55, wherein the receiving interrupt translation unit is operable to detect the write to the control register write and generate the interrupt detectable by the processor.

57. The reconfigurable data center of claim 49, wherein the device comprises one of a disk, a graphics adaptor, and a network interface.
